(19) United States
(12) Patent Application Publication
(10) Pub. No.: US 2002/0158861 A1
(43) Pub. Date: Oct. 31, 2002

(54) Method and apparatus for performing automatic display contrast adjustment in a battery powered device

(76) Inventors: Borisav Maksimovic, Burnaby (CA); Lora Fudimova, Richmond (CA)

Correspondence Address: HARRINGTON & SMITH, LLP, 4 RESEARCH DRIVE, SHELTON, CT, 06484-6212, US

(21) Appl. No.: 09/841,863

(22) Filed: Apr. 25, 2001

(51) Int. Cl. G09G 5/00

(52) U.S. Cl. 345/211

(57) ABSTRACT

A mobile station includes a LCD, a battery and a battery charging circuit that outputs a signal that is indicative of a temperature of the battery. The mobile station further includes a processor coupled to the LCD and to the signal and, in response to the signal, determines an indication of the temperature of the battery. In accordance with the determined indication of the temperature, the processor electrically adjusts the contrast of the LCD. The processor is coupled to an output of a battery temperature sensor, such as an NTC resistor, for reading a digital representation of the battery temperature signal, where the battery temperature signal is also used during a recharging operation to monitor battery temperature. The mobile station may further include a user input for enabling an operator to manually set the contrast of the LCD, and in this case the processor adjusts the contrast of the LCD so as to maintain a contrast set by the operator.

### FIELD OF THE INVENTION

These teachings relate generally to displays, in particular liquid crystal displays (LCDs), and to methods and apparatus for adjusting the contrast of LCD displays.

### BACKGROUND OF THE INVENTION

One problem experienced with LCDs is their poor visibility at low temperatures due to low contrast between the displayed characters or graphics and the background. While this problem may not be apparent for LCDs that are normally operated at room temperature, in a battery powered mobile device, such as a cellular telephone, personal communicator or a personal digital assistant, operation may occur at low ambient temperatures. Under these conditions the LCD may be difficult to read, thereby impeding the use of the device of which the LCD forms a part.

In many modern devices a capability is provided for the user to adjust the LCD contrast. While this procedure is effective at room temperature, it can actually make operation at lower temperatures more problematic, as the user typically adjusts the contrast to be less than the maximum. As such, the user is required to re-adjust the LCD contrast when the device is first used in cold ambient temperature conditions, and then possibly re-adjust the contrast again as the device warms during use.

It is known in the art to provide control over the backlight of a LCD as a function of temperature. For example, U.S. Pat. No. 6,069,449, issued May 30, 2000, “Backlight Control Device for an LCD” by Murakami, discloses the use of a backlight temperature sensor (a thermistor/resistor combination) for sensing the temperature of the backlight (a fluorescent tube) of a LCD in a digital camera. The backlight power is controlled as a function of the backlight temperature, the type of battery and the remaining power in the battery. This technique is said to prevent the brightness of the LCD panel from decreasing even in a low temperature environment, and to provide an easy-to-see image display that is little effected by temperature.

In U.S. Pat. No. 6,069,448, issued May 30, 2000, “LCD Backlight Converter Having a Temperature Compensating Means for Regulating Brightness”, by Yeh, there is described the use of cold cathode fluorescent lamp, driven by a pulse width modulator (PWM), as a backlight circuit for a LCD. A temperature sensor is used to detect the environmental temperature. The output voltage level of a DC lamp supply, and the frequency of the PWM, are both controlled by a measured temperature variation.

U.S. Pat. No. 5,198,747, issued Mar. 30, 1993, “Liquid Crystal Display Driver and Driver Method”, by Haight, discloses a circuit for generating a plurality of driving voltages for a LCD. A reference voltage source is dependent on temperature variations of the LCD and controls the levels of the driving voltages. The reference voltage source includes a band-gap voltage source.

One perceived disadvantage to these prior art approaches is that additional circuitry is required to measure the temperature, thereby increasing both cost and complexity.

### SUMMARY OF THE INVENTION

The foregoing and other problems are overcome by methods and apparatus in accordance with embodiments of these teachings.

A battery-powered device that includes a LCD also includes a processor for determining an indication of a temperature of a battery of the battery-powered device. The processor electrically adjusts the contrast of the LCD in accordance with the determined indication of the temperature. In a preferred, but not limiting, embodiment, the battery-powered device is a mobile station, such as a cellular telephone. The processor is coupled to an output of a battery temperature sensor for reading a digital representation of the battery temperature signal. The battery temperature signal is also used during a recharging operation to monitor battery temperature.

A method for operating the battery powered device is also disclosed.

A mobile station in accordance with these teachings includes a LCD, a battery and a battery charging circuit that outputs a signal that is indicative of a temperature of the battery. The mobile station further includes a processor that is coupled to the LCD and to the signal and, in response to the signal, determines an indication of the temperature of the battery. In accordance with the determined indication of the temperature, the processor electrically adjusts the contrast of the LCD. The processor is coupled to an output of a battery temperature sensor, such as an NTC resistor, for reading a digital representation of the battery temperature signal, where the battery temperature signal is also used during a recharging operation to monitor battery temperature. The mobile station may further include a user input for enabling an operator to manually set the contrast of the LCD, and in this case the processor adjusts the contrast of the LCD so as to maintain a contrast set by the operator.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is block diagram of a mobile station constructed in accordance with these teachings to include an automatic LCD contrast adjustment sub-system that is responsive to an already present battery temperature (BTEMP) signal; and

FIG. 2 is a logic flow diagram in accordance with a method of these teachings.

### DETAILED DESCRIPTION OF THE PREFERRED EMBODIMENTS

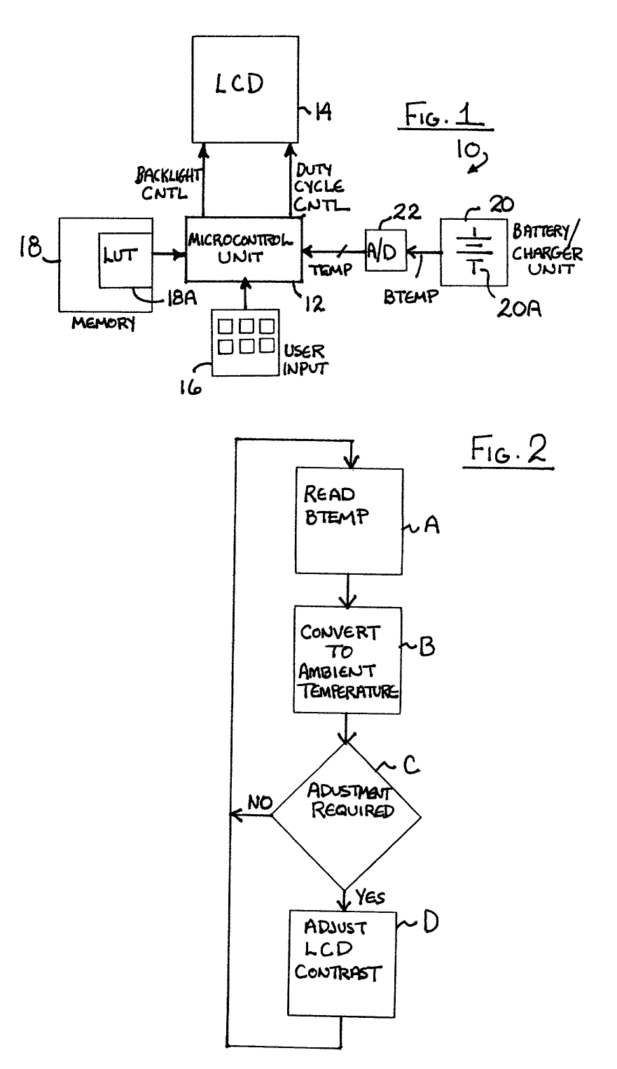

Reference is made to FIG. 1 for showing an embodiment of a portion of a battery powered device, such as a mobile station 10, that is constructed and operated in accordance with these teachings. The mobile station 10 may be a handheld cellular telephone, or a personal communicator, and is assumed to include a wireless (RF) section that is not shown so as to simplify the drawing. The mobile station 10 includes a microcontrol unit (MCU) 12, typically a microprocessor or other type of data processor, a LCD 14, a user input 16, such as a keypad, a memory 18, a battery/charger unit 20 containing a battery 16A, and an analog-to-digital (A/D) converter 22. The A/D converter 22 receives an already present signal from the battery/charger unit 20, i.e., Battery Temperature (BTEMP), and converts BTEMP to a digital representation thereof, labeled for convenience as TEMP. TEMP is input to the MCU 12 and is processed thereby to obtain an indication of the ambient temperature, or at least an indication of the temperature of the mobile station 10, in particular the temperature of the LCD 14. This processing can be conducted in cooperation with a look-up table (LUT) 18A stored in the memory 18, whereby the magnitude of TEMP is converted to an actual temperature measurement (in Celsius or Fahrenheit), or at least an indication of the temperature. The LUT may contain factory calibration values that correlate various values of BTEMP with ambient temperatures. Alternatively, the LUT 18A may be eliminated and the indication of temperature may be derived algorithmically using the value of TEMP. Based on the looked-up or computed temperature measurement or indication, the MCU 12 electrically sets, for example, at least one of a LCD backlight control or LCD duty cycle so as to adjust the contrast ratio thereof accordingly. That is, for a lower temperature indication the contrast is increased, and for a subsequently higher temperature indication the contrast is decreased. In this manner fully automatic control over the LCD 16 contrast is achieved.

It is important to note that the foregoing LCD contrast adjustment procedure does not require the addition of separate temperature measuring circuitry to the mobile station 10, as the BTEMP signal is a signal already provisioned in the mobile station 10, as is the A/D converter 22. The BTEMP signal is normally used during a battery charging operation for monitoring the temperature at or near to the battery 20A. Reference with regard to battery charging systems and the use of battery temperature measurement can be made, by example, to U.S. Pat. No. 6,100,672, issued Aug. 8, 2000, “Start Up Charging Control” by Siponen, and to U.S. Pat. No. 5,489,834, issued Feb. 6, 1996, “Battery Type and Temperature Identification Circuit”, by Pitkanen. Both of these patents describe the use of a negative temperature coefficient (NTC) resistor for measuring battery temperature, and both are incorporated by reference herein in their entireties. In other embodiments of this invention other types of temperature sensing components may be used, such as a p-n junction type of temperature sensor, or a thermistor. In any of these various embodiments what is measured is a temperature associate with the battery 20A or otherwise indicative of the battery temperature, whether it be directly at, on or within the battery 20A, or near to the battery 20A, or at some component associated with the battery 20A, such as a series resistance through which battery current passes.

Through the user input 16 an operator of the mobile station 10 may be enabled, in cooperation with the MCU 12, to manually adjust the contrast of the LCD 14. In this case it may be desirable to override or suspend the automatic adjustment of the LCD contrast so as to adjust and set the contrast in accordance with the operator's preference.

The goal of the automatic LCD 16 contrast adjustment procedure is to maintain the contrast at some default value, or to maintain the contrast at or near a contrast value previously set by the user. For example, assume that the user set the LCD contrast for some value under room temperature conditions, then carried the mobile station 10 out of doors where the temperature was significantly colder. In this case the MCU 12 operates to increase the contrast (such as by increasing the backlighting) to compensate for the temperature-induced decrease in contrast, and to bring the effective LCD contrast back up to a level that corresponds (visually) to the user's setting. If the mobile station 10 is then carried indoors, as the mobile station warms back up to the ambient room temperature, the contrast is reduced accordingly so as to maintain the contrast at the user-defined level.

These teachings assume that under normal operating conditions the temperature of the battery 20A approximates the temperature of the LCD 16, at least to within a few degrees. This will normally be the case, except during a battery recharging operation when the heat generated by the battery 20A can have a significant influence on the magnitude of BTEMP. However, the MCU 12 is aware of when a recharging operation is in progress, and may during this time suspend the automatic adjustment of the LCD 16. In any event, and except for the possible case of a handheld mobile station 10 that is being recharged from an accessory jack in a vehicle, during recharging operations the mobile station 10 is either not in use, or is at least being used in an indoor environment that is not subject to low temperatures that would adversely affect the contrast of the LCD 16.

FIG. 2 depicts a method in accordance with these teachings. At block A the MCU 12 reads the value of TEMP, which is the digitized version of BTEMP, the battery temperature signal. At block B the MCU 12 converts TEMP to an indication of the ambient temperature, or at least to a value that is indicative of the current temperature of the LCD 16. At block C a determination is made if a contrast adjustment is required. This determination can be based on whether the temperature indication derived in block B has decreased or increased by some predetermined increment since a last adjustment was made, or from some steady-state value that was measured if no adjustment has yet been made. If no adjustment is indicated, then control passes back to block A (some suitable time delay may occur (e.g., 1 minute)). If an adjustment is indicated, control passes to block D, where the MCU 12 adjusts the LCD 14 contrast by some amount depending on whether the temperature has been indicated as increasing or decreasing. This can be achieved, for example, by increasing or decreasing the brightness of the LCD backlight, by increasing or decreasing the duty cycle of the LCD driving signals, or by a combination of both. Control then passes back to block A, preferably after the suitable time delay.

Although described in the context of the mobile station 10, such as a cellular telephone, it should be appreciated that these teachings may be applied to other types of battery-powered devices that include, but are not limited to, portable computers, digital cameras and PDAs.

Thus, while these teachings have been particularly shown and described with respect to preferred embodiments thereof, it will be understood by those skilled in the art that changes in form and details may be made therein without departing from the scope and spirit of these teachings.

What is claimed is:

1. A method for adjusting the contrast of a LCD in a battery-powered device, comprising:
determining an indication of a temperature of a battery of the battery-powered device; and
adjusting the contrast of the LCD in accordance with the determined indication of the temperature.

2. A method as in claim 1, wherein the battery-powered device is comprised of a mobile station.

3. A method as in claim 1, wherein the step of determining an indication of the temperature of the battery of the battery-powered device includes reading a value of a battery temperature signal that is used during a recharging operation to monitor battery temperature.

4. A battery-powered device having a LCD, comprising a processor for determining an indication of a temperature associated with a battery of the battery-powered device and for electrically adjusting the contrast of the LCD in accordance with the determined indication of the temperature.

5. A battery-powered device as in claim 4, wherein the battery-powered device is comprised of a mobile station.

6. A battery-powered device as in claim 4, wherein the battery-powered device is comprised of a digital camera.

7. A battery-powered device as in claim 4, wherein the battery-powered device is comprised of a portable computer.

8. A battery-powered device as in claim 4, wherein the battery-powered device is comprised of a personal digital assistant.

9. A battery-powered device as in claim 4, wherein said processor is coupled to an output of a battery temperature sensor for reading a digital representation of a battery temperature signal, where the battery temperature signal is used during a recharging operation to monitor battery temperature.

10. A mobile station, comprising:
a LCD;
a battery and a battery charging circuit outputting a signal that is indicative of a temperature of the battery; and
a processor coupled to said LCD and to said signal and being responsive to said signal for determining an indication of a temperature of said battery and electrically adjusting the contrast of the LCD in accordance with the determined indication of the temperature.

11. A mobile station as in claim 10, wherein said processor is coupled to an output of a battery temperature sensor for reading a digital representation of the battery temperature signal, where the battery temperature signal is used during a recharging operation to monitor battery temperature.

12. A mobile station as in claim 10, and further comprising a user input for enabling an operator to manually set the contrast of the LCD.

13. A mobile station as in claim 12, wherein said processor adjusts the contrast of said LCD so as to maintain a contrast set by the operator.
